(19) United States
(12) Patent Application Publication
(10) Pub. No.: US 2026/0105695 A1
(43) Pub. Date: Apr. 16, 2026

(54) METHODS AND SYSTEMS FOR RENDERING A SCENE IN A HEAD MOUNTED DEVICE

(71) Applicant: SAMSUNG ELECTRONICS CO., LTD., Suwon-si (KR)

(72) Inventors: Rudramani DUBEY, Bengaluru (IN); Burra Srihith BHARADWAJ, Bengaluru (IN); Gaurav PAWAR, Bengaluru (IN); Sathyanarayanan KULASEKARAN, Bengaluru (IN); Sourav THAKUR, Bengaluru (IN)

(73) Assignee: SAMSUNG ELECTRONICS CO., LTD., Suwon-si (KR)

(21) Appl. No.: 19/240,521

(22) Filed: Jun. 17, 2025

Related U.S. Application Data
(63) Continuation of application No. PCT/KR2025/095274, filed on Apr. 22, 2025.

(30) Foreign Application Priority Data
Oct. 11, 2024 (IN) 202441077263

(51) Int. Cl. G06T 19/00; G06T 5/50

(52) U.S. Cl. CPC G06T 19/00; G06T 5/50; G06T 2210/44

(57) ABSTRACT

A method for rendering a real-world scene being captured by a Head Mounted Device (HMD), may include: rendering, at a first position of the HMD, a first image of the real-world scene via a primary camera of the HMD; capturing, using one or more secondary cameras of the HMD, one or more secondary images of the real-world scene; generating, based on a detection of a movement of the HMD to a second position, a warped image using the first image, the warped image corresponding to the second position; identifying, in the warped image, one or more missing pixels by correlating the warped image with the one or more secondary images; generating an output image, corresponding to the second position of the HMD, by filling the one or more missing pixels in the warped image; and rendering, in the HMD, the output image on a display.

### CROSS-REFERENCE TO RELATED APPLICATIONS

This application is a continuation application of International Application No. PCT/KR2025/095274, filed on Apr. 22, 2025, which is based on and claims priority to Indian Patent Application number 202441077263, filed on Oct. 11, 2024, in the Indian Patent Office, the disclosures of which are incorporated by reference herein in their entireties.

### BACKGROUND

### 1. Field

The present disclosure generally relates to the field of display devices and more particularly to a method and system for rendering a real-world scene in Head Mounted Devices such as Visual See Through devices.

### 2. Description of Related Art

Generally, images and videos are preferable sources for users to consume content. The images and videos assist users in learning and understanding different types of content, for example, working on components, concepts, etc. The video is recorded and rendered by a device, for example, a mobile, a video camera, etc. Viewing experience via display devices such as a mobile phone, laptop, LED display devices, and the like, is generally restricted to a 2-Dimensional (2-D) space.

A Visual See Through (VST) device is an electronic display device that allows the user to see what is shown on the screen while still being able to see through the screen. Examples of VST devices include head-up displays, augmented reality systems, and the like. The VST device may be a Head Mounted Display (HMD) device. The VST device may be mounted on a user's forehead covering the eyes of the user. The VST device includes a display screen (digital screen) between the real world and the eyes of the user. The screen is a see-through screen and is typically placed very close to the eyes of the user as shown in related art FIG. 1.

FIG. 1 illustrates a scenario 100 depicting a real-world scene 100S being captured using a Visual See Through (VST) device 150, in the related art. The real-world scene 100S may be captured in the form of images or series of images, and the like and rendered on a screen of the device 150. The VST device 150 gives viewers a more immersive viewing experience via a pass-through mode of the VST device 150. In the pass-through mode, the user is able to see the real world in real-time while wearing the VST device 150. For a delightful user experience, the pass-through mode of the VST device 150 should be able to mimic the pair of human eyes as closely as possible. To realize the pass-through mode, the VST device 150 has a display and includes a pair of cameras (depicting each eye of the pair of eyes of a human being). The two cameras capture a scene of the real-world and project the scene on the transparent display (digital screen) of the VST device 150 in real-time.

The pass-through mode of the VST device 150 may be enabled in various scenarios such as a Mixed Reality scenario. In the mixed reality scenario, the attention of the user is more focused on the virtual content. The pass-through mode may be enabled during an Augmented Reality (AR) scenario, wherein the user has his full attention on the AR content. The user, and in turn the VST device 150, may move during such experiences. As a result of which, the real-world scene 100S being rendered may change. It is desired that the passthrough experience of the VST device 150 during such movements is as seamless as possible.

For example, in a real-world scenario, when the user takes a step towards an object, the object immediately gets closer to the user in real time. However, while wearing the VST device 150, the object does not get closer in real-time and there is generally a delay. The delay is in the order of a few milliseconds and typically 16 milliseconds depending on the VST device. Therefore, the user wearing the VST device 150 sees the real-world with a certain delay. The time delay between capturing the images of the real-world scene 100S and rendering on the screen of the VST device 150 is called latency.

FIGS. 2A and 2B, of the related art, illustrate a scenario 200 where the user of the VST device 150 moves, while wearing the VST device 150 from a first position to another position, in accordance with the related art. FIG. 2A shows the movement and an orientation of the VST device 150 with respect to an object 210 of the real-world scene 100S. The latency of the VST device may be 16 ms. In a situation where the user's head and, in turn, the VST device 150 does not move or may move very slowly, the latency may be an issue, but not a critical issue. But when the users head and, in turn, the VST device 150 is moving fast, the latency will cause severe issues. The VST device 150 moves from a position P1 (T=0 milliseconds) to a position P2 (T=8 milliseconds) and finally from the position P2 to a position P3 (T=16 milliseconds). FIG. 2B shows the views of the object 210 from the positions P1, P2, and P3. In a real-world scenario, at position P3, the user sees the view V3of the object 210c. Likewise, at position P1, the user sees the view V1 of the object 210a. at position P2, the user sees the view V2 of the object 201b. The objects 210a, 210b and 210c may be the object 210 of the FIG. 2A.

This may not be true when the user is wearing the VST device 150 since before the image is rendered on the display and shown to the user, the user would have moved to a new position. The user may still be viewing the view V1 of the object 210a as at position P1 if the latency is 16 milliseconds or more. This will make the user feel sick since his vestibular cues and his visual cues are separated in time by the latency. Therefore, reducing the latency is critical for a smooth viewing experience.

Late Stage Reprojection (LSR) is a technique that warps the rendered image before sending it to the display to correct the head movement of the user wearing the VST device. LSR can reduce latency and increase or maintain frame rate. LSR modifies the rendered image with freshly collected positional information from an Inertial Measurement Unit (IMU) of the VST device and then renders the modified image to the screen of the VST device. As a result, it corrects the image for the new position even before the next frame is rendered.

But LSR is simply a homographic transformation between two planes that is useful in perspective correction without considering the new details of the view at the new position of the VST device. When LSR is applied on an image, the image is transformed to the new position, but this transformation also causes image artefacts since the transformation misses the details of the view with respect to the new position of the VST device. The artefacts may appear as black spots in the image. The image rendered by LSR transformation has missing pixels and is not able to depict the correct true view from the perspective of the new position of the device. This affects the user's immersive experience while using the device.

Therefore, in view of the above-mentioned problems, it is advantageous to provide an improved system and method that can overcome the above-mentioned problems and limitations associated with the partial frame delivery in the VST devices.

### SUMMARY

This summary is provided to introduce a selection of concepts, in a simplified format, that are further described in the detailed description of the disclosure. This summary is neither intended to identify key or essential inventive concepts of the invention nor is it intended for determining the scope of the disclosure.

According to one or more example embodiments, a method for rendering a real-world scene being captured by a Head Mounted Device (HMD), may include: rendering, at a first position of the HMD, a first image of the real-world scene via a primary camera of the HMD on a display; capturing, using one or more secondary cameras of the HMD, one or more secondary images of the real-world scene; generating, based on a detection of a movement of the HMD to a second position, a warped image using the first image, the warped image corresponding to the second position; identifying, in the warped image, one or more missing pixels by correlating the warped image with the one or more secondary images; generating an output image, corresponding to the second position of the HMD, by filling the one or more missing pixels in the warped image; and rendering, in the HMD, the output image on the display.

According to one or more example embodiments, a system for rendering a real-world scene being captured by a Head Mounted Device (HMD), may include: a display; memory storing instructions; and at least one processor configured to execute the instructions, wherein the instructions, when executed by the at least one processor, cause the system to: render, at a first position of the HMD, a first image of the real-world scene via a primary camera on the display; capture, using one or more secondary cameras of the HMD, one or more secondary images of the real-world scene; generate, based on a detection of a movement of the HMD to a second position, a warped image using the first image, the warped image corresponding to the second position; identify, in the warped image, one or more missing pixels by correlating the warped image with the one or more secondary images; generate an output image, corresponding to the second position of the HMD, by filling the one or more missing pixels in the warped image; and render, in the HMD, the output image on the display.

To further clarify the advantages and features of the present disclosure, a more particular description of the disclosure will be rendered by reference to specific embodiments thereof, which is illustrated in the appended drawing. It is appreciated that these drawings depict only typical embodiments of the disclosure and are therefore not to be considered limiting its scope. The disclosure will be described and explained with additional specificity and detail with the accompanying drawings.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates a scenario depicting a real-world scene being captured using a Visual See Through (VST) device, in the related art;

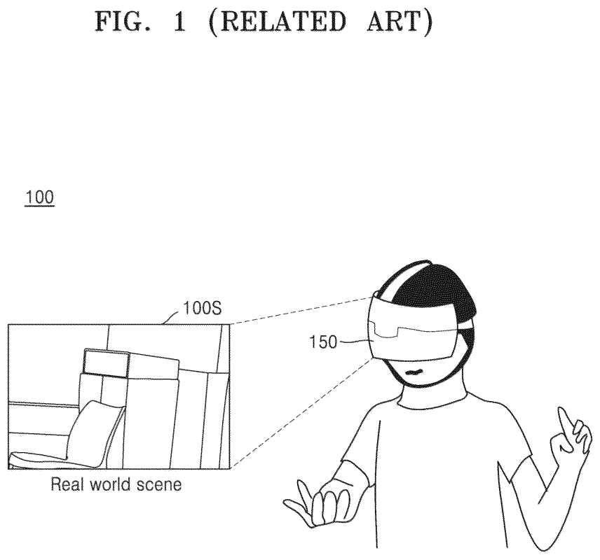

FIG. 2A illustrates a scenario where the user of the VST device moves while wearing the VST device from a first position to another position, in accordance with the related art;

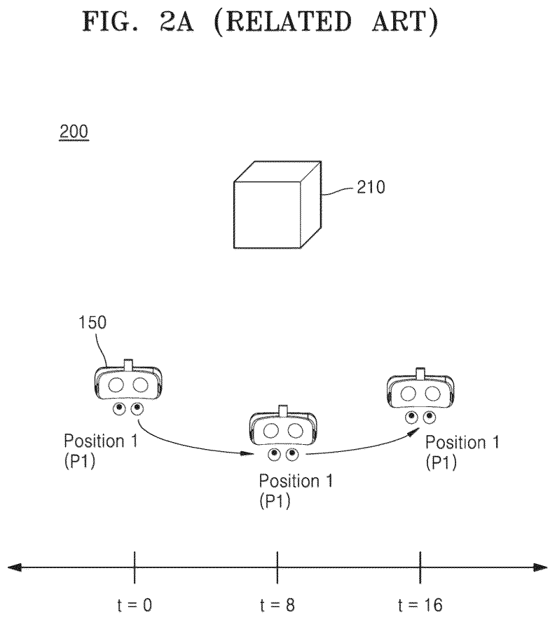

FIG. 2B illustrates a scenario where the user of the VST device moves while wearing the VST device from a first position to another position, in accordance with the related art;

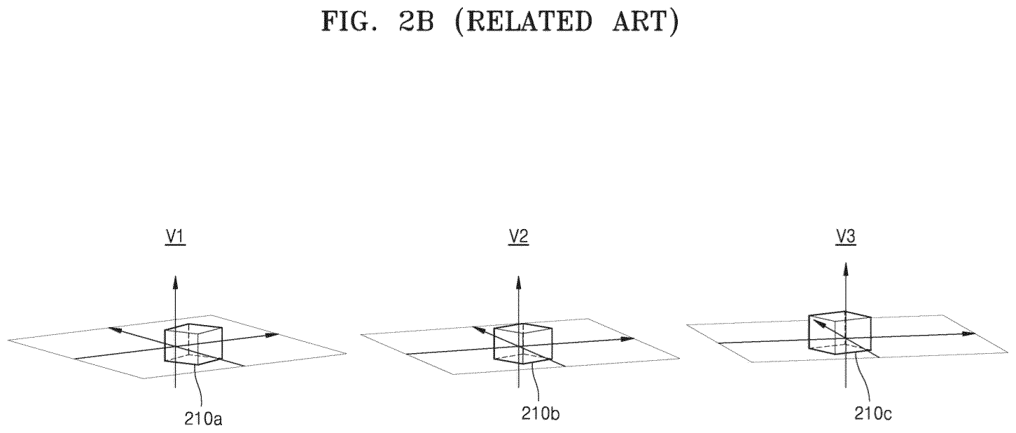

FIG. 3 illustrates an environment comprising a system for rendering a real-world scene being captured in a Head Mounted Device (HMD) (interchangeably referred herein as the device), in accordance with one or more embodiments of the present disclosure;

FIG. 4 illustrates the system for rendering the real-world scene being captured in the device, in accordance with one or more embodiments of the present disclosure;

FIG. 5 illustrates a process flow of the system for rendering the scene, in accordance with one or more embodiments of the present disclosure;

FIG. 6A illustrates a process flow of a renderer and a generating module of the system, in accordance with one or more embodiments of the present disclosure;

FIG. 6B illustrates an example transformation matrix calculated from the metrics coming from IMU, in accordance with one or more embodiments of the present disclosure;

FIG. 7A illustrates a process flow of the working of a capturing module of the system for rendering the real-world scene, in accordance with one or more embodiments of the present disclosure;

FIG. 7B illustrates a difference between Field of Views (FOVs) of one or more secondary cameras and an FOV of a primary camera of the device, in accordance with one or more embodiments of the present disclosure;

FIG. 8 illustrates a process flow illustrating the working of a missing pixels identifying module of the system, in accordance with one or more embodiments of the present disclosure;

FIG. 9 illustrates a process flow illustrating the working of a missing pixels identifying module of the system, in accordance with one or more embodiments of the present disclosure;

FIG. 10A illustrates a process flow illustrating an image generator of the system, in accordance with one or more embodiments of the present disclosure;

FIG. 10B illustrates a table representing exemplary pixel values for regions in the image and GV pixel values for the identified missing pixels and

FIG. 11 is a flowchart illustrating a method for rendering a real-world scene being captured in the device, in accordance with one or more embodiments of the present disclosure.

Further, skilled artisans will appreciate that elements in the drawings are illustrated for simplicity and may not have necessarily been drawn to scale. For example, the flow charts illustrate the method in terms of the most prominent operations involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

The term “some” or “one or more” as used herein is defined as “one”, “more than one”, or “all.” Accordingly, the terms “more than one,” “one or more” or “all” would all fall under the definition of “some” or “one or more”. The term “an embodiment”, “another embodiment”, “some embodiments”, or “in one or more embodiments” may refer to one embodiment or several embodiments, or all embodiments. Accordingly, the term “some embodiments” is defined as meaning “one embodiment, or more than one embodiment, or all embodiments.”

The terminology and structure employed herein are for describing, teaching, and illuminating some embodiments and their specific features and elements and do not limit, restrict, or reduce the spirit and scope of the claims or their equivalents. The phrase “exemplary” may refer to an example.

More specifically, any terms used herein such as but not limited to “includes,” “comprises,” “has,” “consists,” “have” and grammatical variants thereof do not specify an exact limitation or restriction and certainly do not exclude the possible addition of one or more features or elements, unless otherwise stated, and must not be taken to exclude the possible removal of one or more of the listed features and elements, unless otherwise stated with the limiting language “mush comprise” or “needs to include”.

Whether or not a certain feature or element was limited to being used only once, either way, it may still be referred to as “one or more features”, “one or more elements”, “at least one feature”, or “at least one element.” Furthermore, the use of the terms “one or more” or “at least one” feature or element does not preclude there being none of that feature or element unless otherwise specified by limiting language such as “there needs to be one or more” or “one or more element is required.”

Unless otherwise defined, all terms, and especially any technical and/or scientific terms, used herein may be taken to have the same meaning as commonly understood by one having ordinary skill in the art.

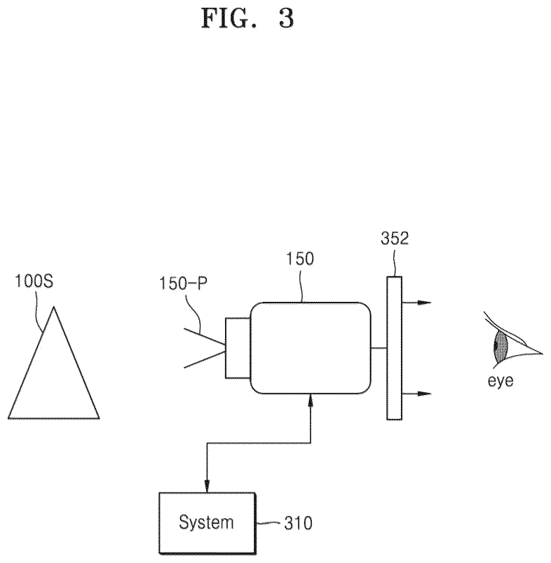

FIG. 3 illustrates an environment 300 comprising a system 310 for rendering a real-world scene 100S being captured in a Head Mounted Device (HMD) 150 (interchangeably referred herein as the device 150), in accordance with one or more embodiments of the present disclosure. The device 150 may be a Visual See Through (VST) display device, which may be worn on the head of a user or as part of a helmet. The device 150 may be a monocular HMD for one eye or a binocular HMD for both eyes of the user. The real-world scene 100S may be captured via a primary camera 150-P of the device 150 in the form of images or series of images, and the like and rendered on a screen (display 352) of the device 150. The device 150 may include one or more secondary cameras 150-S. The system 310 is communicably coupled with the device 150 for rendering the real-world scene 100S in the form of images or videos.

In various embodiments, the device 150 may be a smartphone, a camera, or any other electronic device using a partial frame delivery mechanism having one or more cameras compatible with capturing or recording images, video, etc. of the real-world scene 100S, without departing from the scope of the present disclosure.

In such embodiments, the device 150 may include multiple layers, for example, an application layer, a file system layer, etc. The application layer may include a video player application, a gallery application, or a camera application, without departing from the scope of the present disclosure. Further, the file system layer may include a file reader, a CoDec, a frame data, and a file writer. The file reader may be configured to read a video recorded by the application layer. The CoDec detects/checks a format of the recorded video (file) and also checks coder-decoder part of the format of the file. Further, the frame data is prepared/formed by the CoDec for rendering a plurality of frames associated with the video on the display 352 of the device 150.

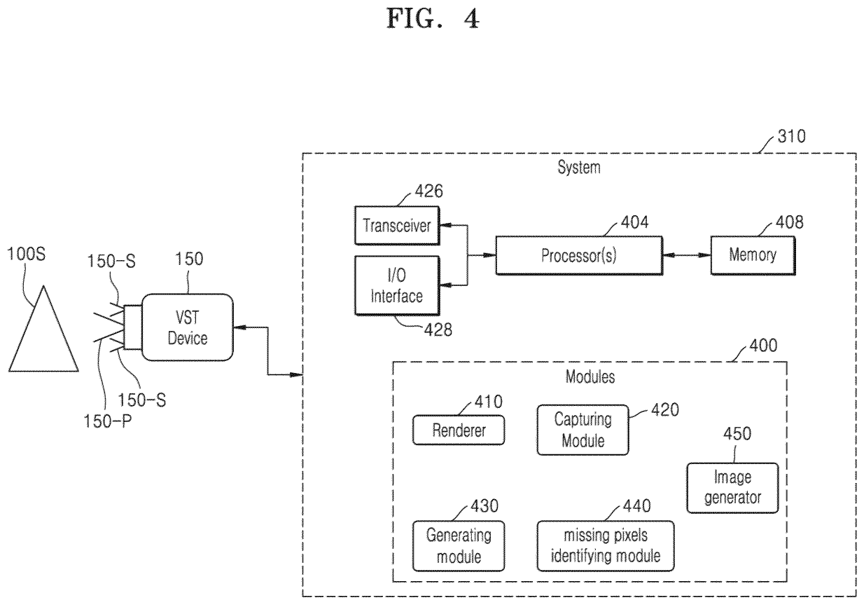

FIG. 4 illustrates the system 310 for rendering the real-world scene 100S being captured in the device 150, in accordance with one or more embodiments of the present disclosure. The system 310 includes a plurality of modules 400 including a renderer 410, a capturing module 420, a generating module 430, a missing pixels identifying module 440 and an image generator 450.

In one or more embodiments, the system 310 includes at least one processor 404, at least one memory 408, a transceiver 426 and an I/O interface 428. The processor 404 may be disposed in communication with a communication network via a network interface. In one or more embodiments, the network interface may be the I/O interface 428. The network interface may connect to the communication network to enable the connection of the system 310 with the device 150. The network interface may employ connection protocols including, without limitation, direct connect, Ethernet (e.g., twisted pair 10/100/1000 Base T), transmission control protocol/internet protocol (TCP/IP), token ring, IEEE 702.11a/b/g/n/x, etc. The communication network may include, without limitation, a direct interconnection, local area network (LAN), wide area network (WAN), wireless network (e.g., using Wireless Application Protocol), the Internet, etc. Using the network interface and the communication network, the system 310 may communicate with other devices. The network interface may employ connection protocols including, but not limited to, direct connect, Ethernet (e.g., twisted pair 10/100/1000 Base T), transmission control protocol/internet protocol (TCP/IP), token ring, IEEE 702.11a/b/g/n/x, etc.

In some embodiments, the memory 408 may be communicatively coupled to the processor 404. The memory 408 may be configured to store data, and instructions executable by the processor 404. In one embodiment, the memory 408 may be provided within the device 150. In an embodiment, the memory 408 may be provided within the system 310 being remote from the device 150. In an embodiment, the memory 408 may communicate with the processor 404 via a bus within the system 310. In an embodiment, the memory 408 may be located remotely from the processor 404 and may be in communication with the processor 404 via a network. The memory 408 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like.

In one example, the memory 408 may include a cache or random-access memory for the processor 404. In alternative examples, the memory 408 is separate from the processor 404, such as a cache memory of a processor, the system memory, or other memory. The memory 408 may be an external storage device or database for storing data. The memory 408 may be operable to store instructions executable by the processor 404. The functions, acts, or tasks illustrated in the figures or described may be performed by the programmed processor 404 for executing the instructions stored in the memory 408. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

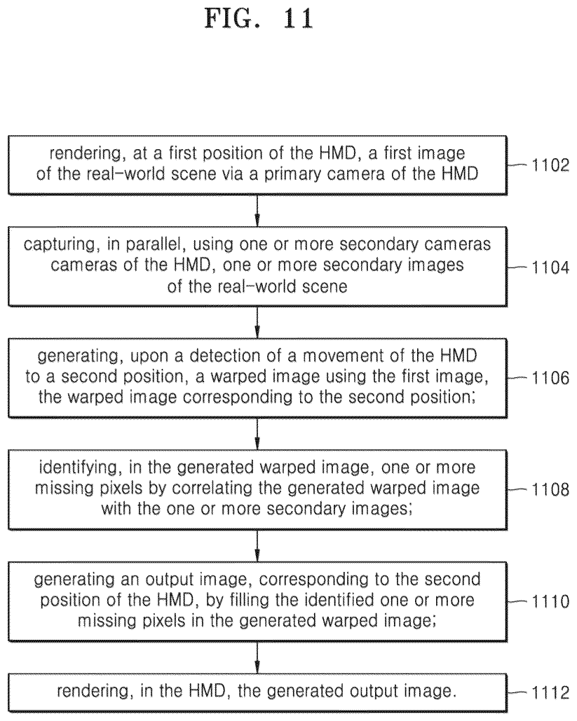

In some embodiments, the plurality of modules 400 may be included within the memory 408. The plurality of modules 400 may include a set of instructions that may be executed to cause the system 310, in particular, the processor 404 of the system 310, to perform any one or more of the methods/processes disclosed herein. The plurality of modules 400 may be configured to perform the operations of the present disclosure using the data stored in the database. For instance, the plurality of modules 400 may be configured to perform the operations disclosed in FIG. 11.

In one or more embodiments, each of the plurality of modules 400 may be a hardware unit which may be outside the memory 408. Further, the memory 408 may include an operating system for performing one or more tasks of the system 310, as performed by a generic operating system. Each of the modules 400 may be in communication with one another and the processor 404. The functionality and working of each of the modules 400 is explained in greater detail with reference to the following Figures.

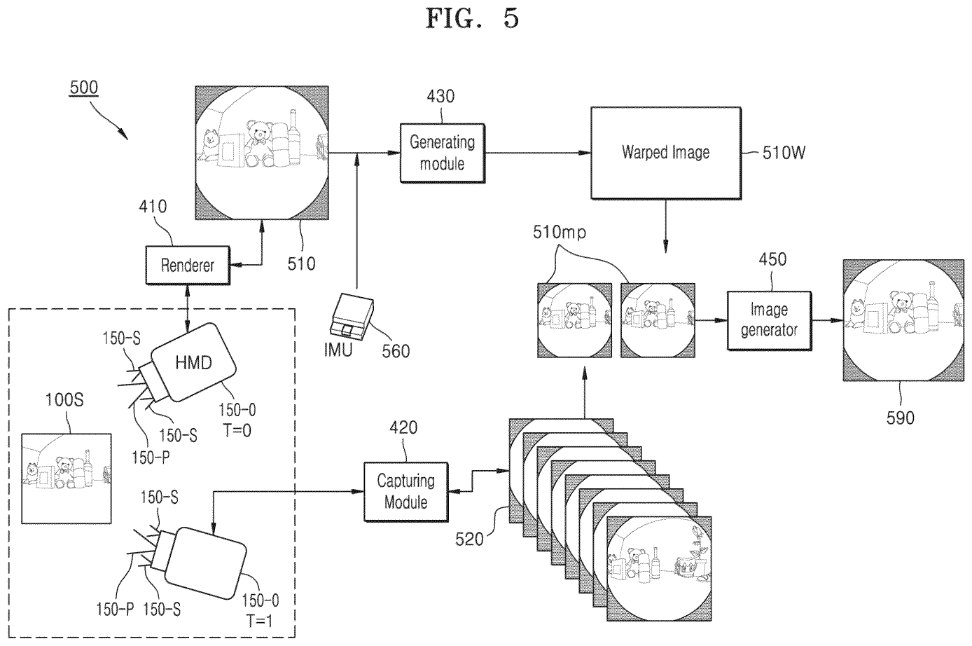

FIG. 5 illustrates a process flow 500 of the system 310 for rendering the real-world scene 100S, in accordance with one or more embodiments of the present disclosure. The renderer 410 is configured for rendering a first image 510 of the real-world scene 100S on the display 352 via the primary camera 150-P at a first position 150-0 of the device 150. The capturing module 420 is configured for capturing, in parallel, one or more secondary images 520 of the real-world scene 100S using the one or more secondary cameras 150-S. Upon a detection of a movement of the device 150 to a second position 150-1, the generating module 430 is configured for generating a warped image 510W using the first image 510. The warped image 510W corresponds to the second position 150-1 of the device 150. The missing pixels identifying module 440 is configured for identifying one or more missing pixels 510mp in the generated warped image 510W by correlating the generated warped image 510W with the one or more secondary images 520.

The image generator 450 is configured for generating an output image 590 by filling the identified one or more missing pixels 510mp in the generated warped image 510W. The output image 590 corresponds to the second position 150-1 of the device 150. Finally, the renderer 410 is configured for rendering the generated output image 590 to the display 352 of the device 150.

The working and functioning of the plurality of modules 400 of the system 310 have been described in detail with reference to the following Figures.

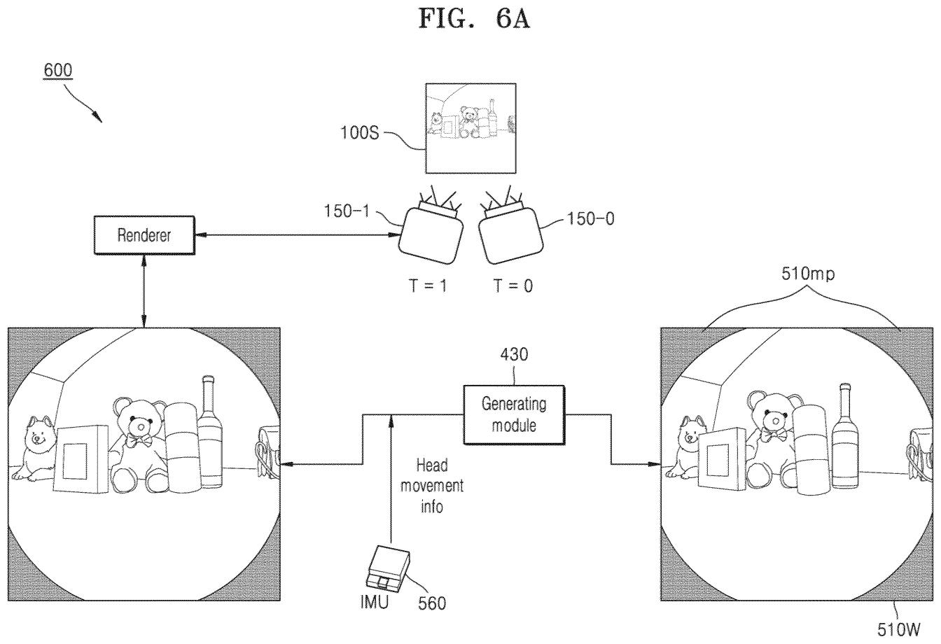

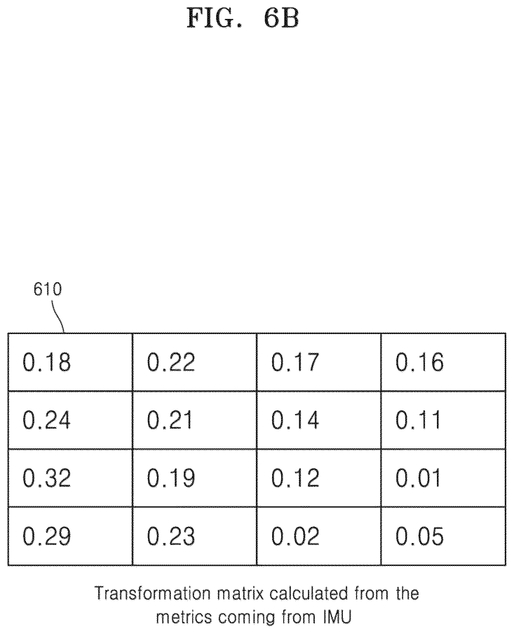

FIG. 6A illustrates a process flow 600 of the renderer 410 and the generating module 430 of the system 310, in accordance with one or more embodiments of the present disclosure. In one or more embodiments, the process flow 600 shows the movement of the device 150 from the first position 150-0 at time, T=0 seconds to the second position 150-1 at time, T=1 seconds for capturing the real-world scene 100S. The renderer 410 renders the first image 510 of the real-world scene 100S on the display 352 of the device 150 at the first position 150-0. When the user moves, turns or changes the orientation of his head, the device 150 is moved to the second position 150-1.

In one or more embodiments, the generating module 430 is further configured for monitoring, continuously, the position of the device 150 for detecting the movement of the device 150 from the first position 150-0 to the second position 150-1 using an Inertial Measurement Unit (IMU) 560 of the device 150. The IMU 560 is configured to measure the change in the position of the device 150 from the first position 150-0 to the second position 150-1. The IMU may be a motion sensor installed in the device 150 which provides continuous data about the acceleration and angular velocity of the device 150 when moving.

A table (transformation matrix 610) is shown in FIG. 6B, which represents the movement of the device 150 from the first position 150-0 to the second position 150-1 in the form of a transformation matrix using the acceleration and angular velocity data from the IMU 560. An orientation of the device 150 including a pitch value, a roll value and a yaw value, and a linear displacement of the device 150 from T=0 seconds to T=1 seconds is measured by the IMU 560. A gyroscope of the IMU 560 may provide the angular velocities, which are integrated with the orientation and the linear displacement to obtain the orientation in terms of Euler angles (pitch, roll and yaw). Subsequently, a rotation matrix is generated using equation (1) as follows:

$$R = Rz ( yaw ) \cdot Ry ( pitch ) \cdot Rx ( roll ) \qquad ( 1 )$$

A translation is computed using an accelerometer of the IMU 560. An integration of the acceleration values in the x, y and z axes is performed twice to obtain the displacement along the respective axes for the first position 150-0. Subsequently, based upon the computed translation, the translation matrix is generated in the form of a 3×1 vector based on equation (2):

$$T = [ Tx , Ty , Tz ] \qquad ( 2 )$$

In an exemplary embodiment for the purpose of explanation in a 2-Dimensional scenario (assuming z=0), combining the rotation and translation matrix, the transformation matrix may be obtained:

| R11 | R12 | Tx |
|---|---|---|
| R21 | R22 | Ty |
| 0 | 0 | 1 |

The warped image 510W obtained using the transformation matrix 610 has the point of view for the user changed to that of the second position 150-1. However, the warped image 510W includes missing pixels 510mp because the pixels available for transformation are from the first position 150-0 at T=0 seconds only. The details of the view from the second position 150-1 are not available in the first image 510.

In one or more embodiments, the generating module 430 is configured for generating the warped image 510W by applying Late Stage Reprojection (LSR) to the first image 510. The LSR is applied based on the measured change in the position of the device 150. The LSR is a technique that warps the first image 510 by modifying the first image using the positional information from the IMU 560 to provide for view correction as per the movement of the device 150. The LSR performs a homographic transformation of the first image 510 from a first plane corresponding to the first position 150-0 to a second plane corresponding to the second position 150-1 of the device 150. The homographic transformation is based on the measured change in the position of the device 150.

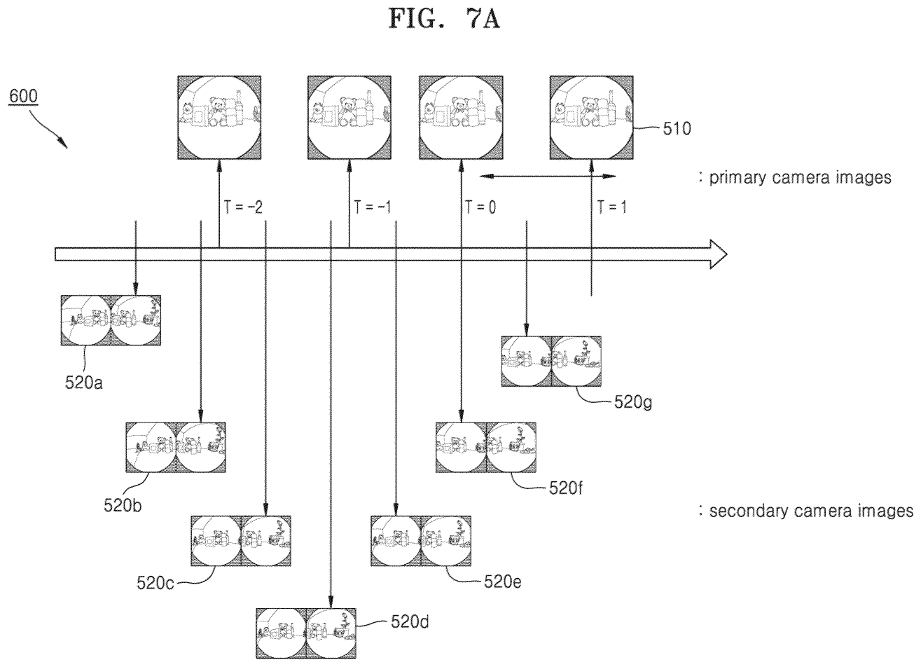

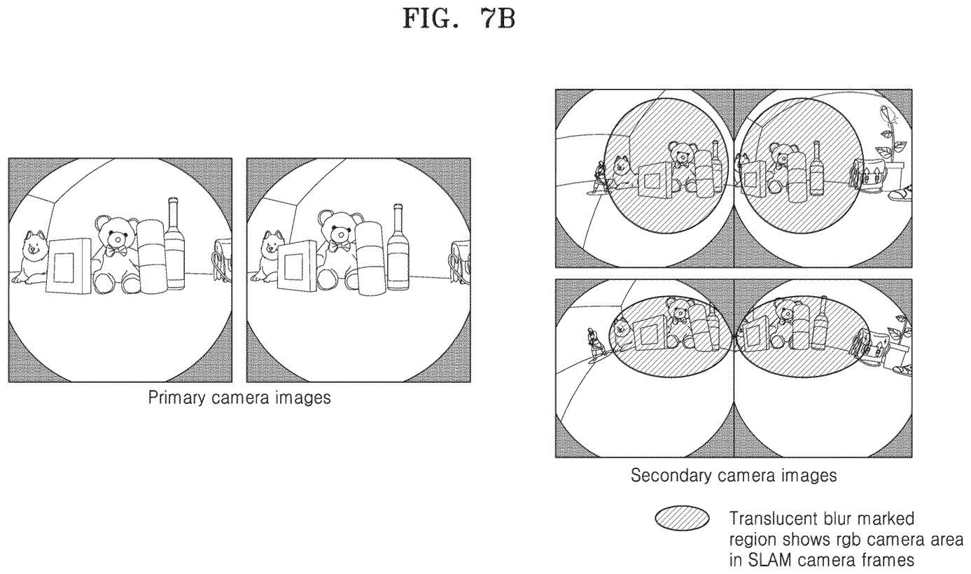

FIG. 7A illustrates a process flow 700 of the working of the capturing module 420 of the system 310 for rendering the real-world scene 100S, in accordance with one or more embodiments of the present disclosure. In one or more embodiments, the process flow 700 illustrates the working of the capturing module from time, T=−2 seconds to time, T=1 second. The capturing module 420 is configured for continuously capturing one or more secondary images 520a-520g of the real-world scene 100S using the one or more secondary cameras 150-S of the device 150. The one or more secondary images 520a-520g of the real-world scene 100S may be images captured at each position changing over time as the one or more secondary cameras 150-S, in other words, VST device 150 moves. In one or more embodiments, the one or more secondary cameras 150-S may be a Simultaneous Localization and Mapping (SLAM) camera. The SLAM camera may be configured to construct and continuously keep updating a map of an unknown environment such as the environment around the real-world scene 100S while simultaneously keeping track of the movement of the user and in turn, the device 150 with respect to the environment.

In one or more embodiments, the capturing module 420 is configured to capture using Field of Views (FOVs) of the one or more secondary cameras 150-S. The FOVs of the one or more secondary cameras 150-S is greater than an FOV of the primary camera 150-P. FIG. 7B illustrates the difference between the FOVs of the one or more secondary cameras 150-S and the FOV of the primary camera 150-P. The capturing module 420 is configured to capture, using the one or more secondary cameras 150-S of the device 150, at a rate of capturing higher than a rate of capturing of the primary camera 150-P. In an exemplary embodiment, the one or more secondary cameras 150-S may capture at a rate of 120 frames per second (fps) and the rate of capturing for the primary camera is 16 ms. Accordingly, for the time duration from T=0 to T=1 when the device moves from the first position 150-0 to the second position 150-1, each of the one or more secondary cameras 150-S captures two secondary images 520f and 520g:

$$\begin{matrix}\begin{matrix}Number of frames captured by \\ the secondary cameras\end{matrix} = Time * camera fps \\ = 0.016 * 120 \\ = 2 frames approximately\end{matrix}$$

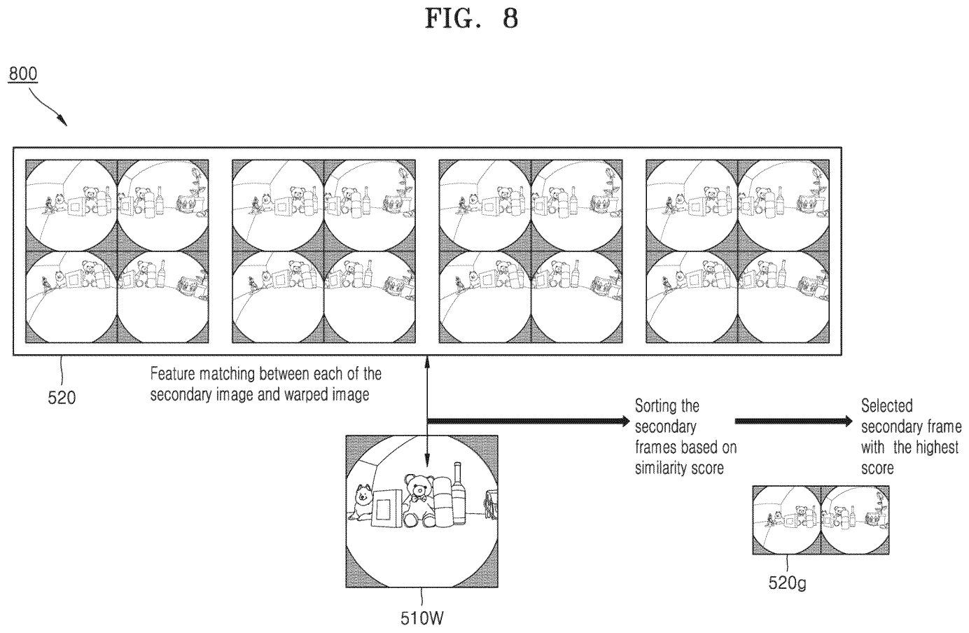

FIG. 8 illustrates a process flow 800 illustrating the working of the missing pixels identifying module 440 of the system 310, in accordance with one or more embodiments of the present disclosure. In one or more embodiments, the missing pixels identifying module 440 is configured for measuring differences, using feature matching, between each of the one or more secondary images 520 and the warped image 510W. Subsequently, the missing pixels identifying module 440 is further configured for assigning a similarity score to each of the one or more secondary images 520 based on the measured difference. Furthermore, the missing pixels identifying module 440 is configured for selecting one of the one or more secondary images 520 with the highest similarity score.

In an exemplary embodiment, based upon the rate of capturing of the one or more secondary cameras 150-S(e.g. 120 fps) and the number of secondary cameras 150-S(e.g. 4 secondary cameras), eight secondary images 520 are captured in a time duration of 16 ms. Further, another 8 secondary images may be captured in another time duration of 16 ms (e.g. from time T=−1 seconds to T=0 seconds). The missing pixels identifying module 440 may be configured to perform feature mapping between the set of 16 secondary images 520 and the first image 510 to select a secondary image 520g with the highest similarity score.

Examples of feature mapping algorithms may include Scale-Invariant Feature Transform (SIFT), SURF, BRIEF, ORB and the like. A set of key points and descriptors in the set of 16 secondary images 520 and the first image 510 is extracted using any of the exemplary algorithms. The descriptors are matched and sorted based on the distance, wherein the lower the distance, the better is the match, and so is the assigned similarity score. The final similarity score may be calculated as an average of the distances of the individual scores corresponding to each descriptor. In one or more embodiments, the selected secondary image may be the image 510g based on the similarity score.

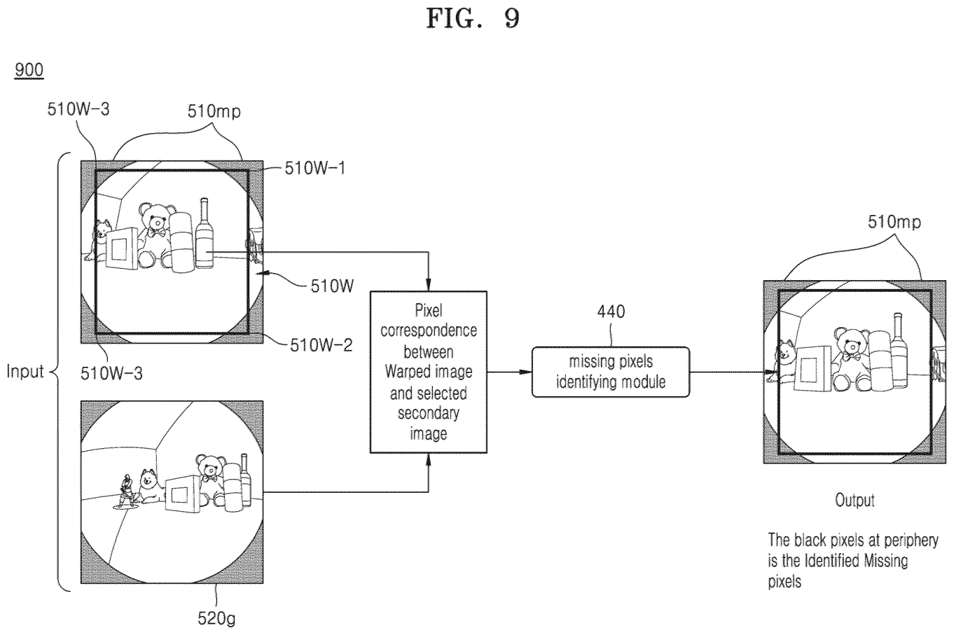

FIG. 9 illustrates a process flow 900 illustrating the working of the missing pixels identifying module 440 of the system 310, in accordance with one or more embodiments of the present disclosure. In one or more embodiments, the missing pixels identifying module 440 is configured for correlating the generated warped image 510W with the selected secondary image 510g.

In one or more embodiments, images may be stored in the form of a One-Dimensional array. The memory buffer may be initialized with values of −1:

| | | | | | | | | | | | | | | | |
|---|---|---|---|---|---|---|---|---|---|---|---|---|---|---|---|
| −1 | −1 | −1 | −1 | −1 | −1 | −1 | −1 | −1 | −1 | −1 | −1 | −1 | −1 | −1 | −1 |

In an exemplary embodiment, the first image 510 may be a 4×4 image represented by:

| | | | |
|---|---|---|---|
| 155 | 160 | 165 | GV |
| 123 | 134 | 132 | GV |
| 144 | 153 | 167 | GV |
| 132 | 244 | 151 | GV |

wherein GV means Garbage Values.

When the first image 510 is warped to generate the warped image 510W, the missing pixels 510mp in the warped image 510W are assigned GV. Accordingly, the values for the missing pixels 510mp will be −1 and hence a pixel value of −1 in the memory buffer will indicate missing pixels 510mp.

In one or more embodiments, the missing pixels identifying module 440 is configured for developing a pixel correspondence between the selected secondary image 510g and the warped image 510W. The pixel correspondence is developed based on the locations of the primary camera 150-P and the one or more secondary cameras 150-S in the device 150. The primary camera 150-P and the one or more secondary cameras 150-S in the device 150 are calibrated and using a depth value of the primary camera 150-P and the secondary cameras 150-S, a corresponding region between the warped image 510W and the selected secondary image 520g may be identified.

The primary camera 150-P and the one or more secondary cameras 150-S of the device 150 are calibrated both on the bases of intrinsic and extrinsic. A set of corner points 510W-1, 510W-2, 510W-3, and 510W-4 of the warped image 510W may be identified from the transformation matrix. In the warped image 510W, the region represented by the rectangle (with corners 510W-1, 510W-2, 510W-3, and 510W-4) has all the pixels from the first image 510. At the peripheral regions just outside the rectangle, the region of missing pixels 510mp (black pixels) has been identified based on the pixel correspondence between the warped image 510W and the selected secondary image 510g and using the four corner points 510W-1, 510W-2, 510W-3, and 510W-4 as reference.

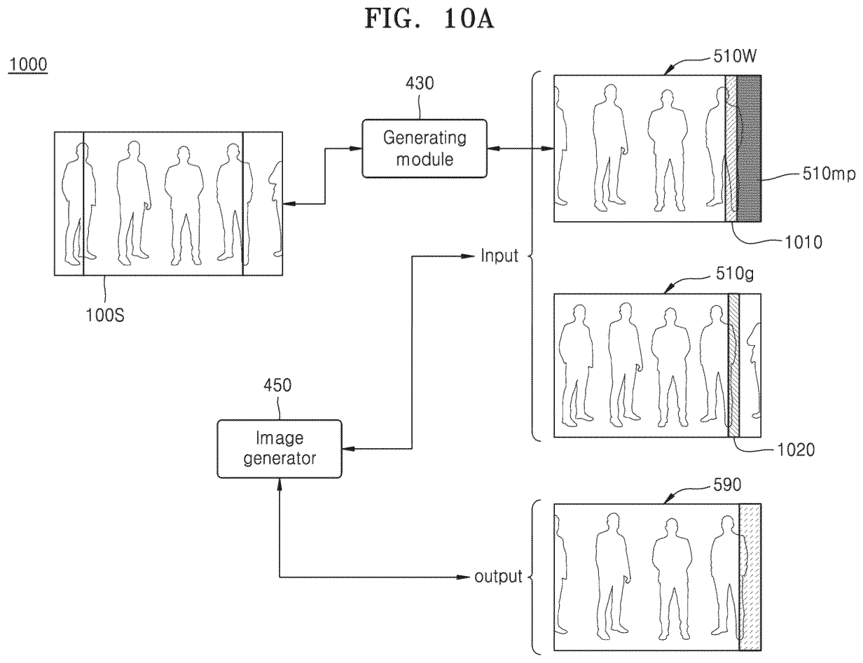

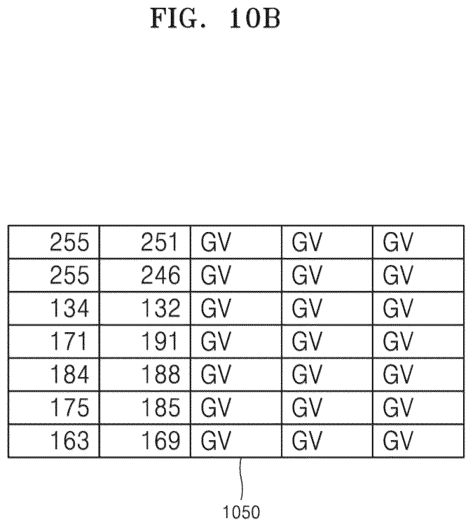

FIG. 10A illustrates a process flow 1000 illustrating the image generator 450 of the system 310, in accordance with one or more embodiments of the present disclosure. The process flow 1000 shows the warped image 510W and the selected secondary image 510g of a real-world scene 100S. In one or more embodiments, the image generator 450 is configured for filling the one or more missing pixels 510mp in the warped image 510W using replacement pixels 1020 from the selected secondary image 520g.

In one or more embodiments, the image generator 450 is configured for determining replacement pixels 1020 in the selected secondary image 510g by identifying reference regions 1010 adjacent to the identified one or more missing pixels 510mp in the warped image 510W. The reference region 1010 of the missing pixels 510mp is identified in the secondary image 510g based on the pixel correspondence. The image generator 450 is further configured for detecting a location, corresponding to the identified reference region 1010, in the selected secondary image 510g and determining the replacement pixels 1020 from the selected secondary image 510g based on the detected corresponding location. The region 1020 (replacement pixels) adjacent to the identified reference regions (boundary region) 1010 is obtained by scanning the secondary image 510g to identify replacement pixels 1020 for filling the missing pixels 510mp in the warped image 510W. Finally, the image generator 450 is configured for concatenating the determined replacement pixels 1020 of the selected secondary image 510g into the warped image 510W by replacing the identified one or more missing pixels 510mp to generate the output image 590. The renderer 410 is configured to render the output image 590 on the display 352 of the device 150.

FIG. 10B shows a table 1050 representing exemplary pixel values for regions 1010 and GV pixel values for the identified missing pixels 510mp.

In one or more embodiments, the missing pixels 510mp in the warped image 510W of FIG. 10A are assigned GV of the table 1050. One or more pixel values are assigned corresponding to the pixels in the identified reference region 1010 of the warped image 510W of FIG. 10A. (e.g. a first column and a second column of the table 150)

FIG. 11 is a flowchart illustrating a method 1100 for rendering a real-world scene being captured in a Head Mounted Device (HMD), in accordance with one or more embodiments of the present disclosure.

Referring to FIGS. 3-10B together, the method 1100 may be performed by the device 150 such as a camera device having the pass-through mode, e.g., a camcorder, a mobile device, a tab with similar capabilities, and the like, based on instructions retrieved from non-transitory computer-readable media. A computer-readable media may include machine-executable or computer-executable instructions to perform all or portions of the described method. The computer-readable media may be, for example, digital memories, magnetic storage media, such as magnetic disks and magnetic tapes, hard drives, or optically readable data storage media.

The method 1100 includes a series of operations shown at operation 1102 through operation 1112 of FIG. 11. The method 1100 may be performed by the system 310 in conjunction with one or more modules 400, the details of which are explained in conjunction with FIGS. 3-10B, and the same are not repeated here for the sake of brevity. The method 1100 begins at operation 1102.

At operation 1102, the method 1100 includes rendering, at a first position 150-0 of the device 150, a first image 510 of the real-world scene 100S via a primary camera 150-P of the device 150. At operation 1104, the method 1100 includes continually capturing, in parallel, one or more secondary images of the real-world scene 100S using one or more secondary cameras 150-S of the device 150. The secondary cameras 150-S have Field of Views (FOVs) which is greater than an FOV of the primary camera 150-P. Further, in the method 1100, capturing by the secondary cameras 150-S is at a rate of capturing higher than a rate of capturing of the primary camera 150-P.

Subsequently, during the use of the device 150 the user wearing the device 150 may move with respect to the real-world scene 100S and in turn the device 150 moves from a first position 150-0 to a second position 150-1 in time, from T=0 seconds to T=1 seconds. The method 1100 includes monitoring, continuously, the position of the device 150 for detecting a movement of the device 150 using an Inertial Measurement Unit (IMU) of the device 150. Further the method 1100 includes measuring a change in the position of the device 150 from the first position 150-0 to the second position 150-1.

Upon the detection of the movement of the device 150 to the second position 150-1, the method 1100, at operation 1106, includes generating a warped image 510W corresponding to the second position 150-1. The method 1100 includes generating the warped image 510W by applying Late Stage Reprojection (LSR) to the first image 510 based on the measured change in the position of the device 150.

At operation 1106, the method 100, while applying the LSR, further includes homographic transformation of the first image 510 from a first plane corresponding to the first position 150-0 to a second plane corresponding to the second position 150-1 of the device 150. Since the warped image 510W is generated from the first image 510, the warped image 510W does not include pixels with respect to the new view from the second position 150-1 of the device 150.

Subsequently, at operation 1108, the method 1100 further includes identifying one or more missing pixels 510mp in the generated warped image 510W by correlating the generated warped image 510W with the one or more secondary images 520. Further, at operation 1108, the method 1100 further includes measuring differences, using feature matching, between each of the one or more secondary images 520 and the warped image 510W, assigning a similarity score to each of the one or more secondary images based on the measured difference and selecting a secondary image 520g with the highest similarity score. Further, the method includes correlating the generated warped image 510W with the selected secondary image 520g by developing a pixel correspondence between the selected secondary image 520g and the warped image 510W. The pixel correspondence is developed based on the locations of the primary camera 150-P and the one or more secondary cameras 150-S of the device 150.

Upon identification of the one or more missing pixels 150mp, the method 1100, at operation 1110, includes generating an output image 590 corresponding to the second position 150-1 of the device 150 by filling the identified one or more missing pixels 510mp in the generated warped image 510W. At operation 1110, the method 1100 further includes identifying reference regions adjacent to the identified one or more missing pixels 510mp in the warped image 510W, detecting a location in the selected secondary image 520g corresponding to the identified reference regions and determining the replacement pixels from the selected secondary image 520g based on the detected corresponding location.

Finally, at operation 1112, the method 1100 includes rendering the generated output image 590 in the device 150.

The system and method of the disclosure take advantage of the secondary images 520 available from the secondary cameras 150-S of the device 150 to fill in the missing pixels 510mp in the warped image 510W to generate the output image 590 corresponding to the second position 150-1 of the device 150. Since the disclosure uses the first image 510 and the secondary images 520 already generated before the next frame from the primary camera 150-P is available for rendering, the latency is reduced, and the user experiences a smoother immersive experience.

The system and method of the disclosure attempts at correcting the artefacts which are present in the warped image 510W generated by applying LSR. The secondary images 520 are used to fill in the missing pixel artefacts in the LSR generated images.

In effect, the disclosure, by filling in the missing pixels 510mp of the warped image 510W, increases the field of view of the user of the device 150. The missing pixels 510mp are not shown black or blank but are filled with corresponding pixels from the secondary images 520 (e.g. SLAM camera images).

The present disclosure attempts to improve the output LSR images thereby enhancing the Immersive Passthrough experience. The system and method of the disclosure is applicable to all devices using pass through mode. Further, XR devices are generally intended majorly for multitasking. The disclosure improves the performance and reduces latency in such devices thereby improving the overall user experience.

The present disclosure enhances passthrough rendering of VST device by detecting a change in head pose of the user from the first head pose to a second head pose and generating RGB image for the second head pose using a warped RGB image corresponding to the first poser by filling missing pixels in the warped RGB image using SLAM images captured during first pose and second pose.

Accordingly, one or more embodiments herein may constitute an improvement to computer functionality (i.e. improving the functioning of the computer itself) by providing a virtual scene rendering with reduced latency (i.e. improving rendering performance). This improves the user experience of a VST device by allowing a user to navigate and interact with an environment in real-time.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A method for rendering a real-world scene being captured by a Head Mounted Device (HMD), the method comprising:
rendering, at a first position of the HMD, a first image of the real-world scene via a primary camera of the HMD on a display;
capturing, using one or more secondary cameras of the HMD, one or more secondary images of the real-world scene;
generating, based on a detection of a movement of the HMD to a second position, a warped image using the first image, wherein the warped image is corresponding to the second position;
identifying, in the warped image, one or more missing pixels by correlating the warped image with the one or more secondary images;
generating an output image, corresponding to the second position, by filling the one or more missing pixels in the warped image; and
rendering, in the HMD, the output image on the display.

2. The method as claimed in claim 1, wherein the capturing the one or more secondary images is performed:
using Field of Views (FOVs) of the one or more secondary cameras, the FOVs of the one or more secondary cameras being greater than an FOV of the primary camera; and
at a rate of capturing higher than a rate of capturing of the primary camera.

3. The method as claimed in claim 1, wherein the generating the warped image comprises:
monitoring a position of the HMD for detecting the movement of the HMD using an Inertial Measurement Unit (IMU) of the HMD; and
measuring a change in the position of the HMD from the first position to the second position.

4. The method as claimed in claim 3, wherein the generating the warped image further comprises applying Late Stage Reprojection (LSR) to the first image, based on the change in the position of the HMD.

5. The method as claimed in claim 3, wherein the generating the warped image further comprises:
homographic transformation of the first image from a first plane corresponding to the first position to a second plane corresponding to the second position, based on the change in the position of the HMD from the first position to the second position.

6. The method as claimed in claim 1, wherein the identifying the one or more missing pixels comprises:
measuring differences, using feature matching, between the one or more secondary images and the warped image;
assigning similarity scores to the one or more secondary images based on the differences;
selecting, from the one or more secondary images, a selected secondary image with a highest similarity score; and
correlating the warped image with the selected secondary image.

7. The method as claimed in claim 6, wherein the identifying the one or more missing pixels further comprises developing a pixel correspondence between the selected secondary image and the warped image, based on locations of the primary camera and the one or more secondary cameras on the HMD.

8. The method as claimed in claim 6, wherein the generating the output image comprises filling the one or more missing pixels in the warped image using replacement pixels from the selected secondary image.

9. The method as claimed in claim 6, wherein the generating the output image comprises determining, in the selected secondary image, replacement pixels corresponding to the one or more missing pixels by:
identifying, in the warped image, reference regions adjacent to the one or more missing pixels;
detecting a corresponding location, corresponding to the reference regions, in the selected secondary image; and
determining the replacement pixels from the selected secondary image based on the corresponding location.

10. The method as claimed in claim 9, wherein the generating the output image comprises concatenating the replacement pixels of the selected secondary image into the warped image by replacing the one or more missing pixels.

11. A system for rendering a real-world scene being captured by a Head Mounted Device (HMD), the system comprising:
a display;
memory storing instructions; and
at least one processor configured to execute the instructions, wherein the instructions, when executed by the at least one processor, cause the system to:
render, at a first position of the HMD, a first image of the real-world scene via a primary camera on the display;
capture, using one or more secondary cameras of the HMD, one or more secondary images of the real-world scene;
generate, based on a detection of a movement of the HMD to a second position, a warped image using the first image, wherein the warped image is corresponding to the second position;
identify, in the warped image, one or more missing pixels by correlating the warped image with the one or more secondary images;
generate an output image, corresponding to the second position, by filling the one or more missing pixels in the warped image; and
render, in the HMD, the output image on the display.

12. The system as claimed in claim 11, wherein the instructions, when executed by the at least one processor, further cause the system to capture the one or more secondary images:
using Field of Views (FOVs) of the one or more secondary cameras, the FOVs of the one or more secondary cameras being greater than an FOV of the primary camera; and
at a rate of capturing higher than a rate of capturing of the primary camera.

13. The system as claimed in claim 11, wherein the instructions, when executed by the at least one processor, further cause the system to:
monitor a position of the HMD for detecting the movement of the HMD (150) using an Inertial Measurement Unit (IMU) of the HMD; and
measure a change in the position of the HMD from the first position to the second position.

14. The system as claimed in claim 13, wherein the instructions, when executed by the at least one processor, further cause the system to generate the warped image by performing homographic transformation of the first image from a first plane corresponding to the first position to a second plane corresponding to the second position, based on the change in the position of the HMD from the first position to the second position.

15. The system as claimed in claim 11, wherein the instructions, when executed by the at least one processor, further cause the system to identify the one or more missing pixels by:
measuring differences, using feature matching, between the one or more secondary images and the warped image;
assigning similarity scores to the one or more secondary images based on the differences;
selecting, from the one or more secondary images, a selected secondary image with a highest similarity score; and
correlating the warped image with the selected secondary image.

16. The system as claimed in claim 15, wherein the instructions, when executed by the at least one processor, further cause the system to identify the one or more missing pixels by developing a pixel correspondence between the selected secondary image and the warped image, based on locations of the primary camera and the one or more secondary cameras on the HMD.

17. The system as claimed in claim 15, wherein the instructions, when executed by the at least one processor, further cause the system to fill the one or more missing pixels in the warped image using replacement pixels from the selected secondary image.

18. The system as claimed in claim 15, wherein instructions, when executed by the at least one processor, further cause the system to determine, in the selected secondary image, replacement pixels corresponding to the one or more missing pixels by:
identifying, in the warped image, reference regions adjacent to the one or more missing pixels;
detecting a corresponding location, corresponding to the reference regions, in the selected secondary image; and
determining the replacement pixels from the selected secondary image based on the corresponding location.

19. The system as claimed in claim 18, wherein instructions, when executed by the at least one processor, further cause the system to concatenate the replacement pixels of the selected secondary image into the warped image by replacing the one or more missing pixels.

20. A non-transitory computer-readable storage medium, having a computer program stored thereon that performs, when executed by a processor, the method according to claim 11.
